(19) United States
(12) Patent Application Publication
(10) Pub. No.: US 2008/0149145 A1
(43) Pub. Date: Jun. 26, 2008

(54) Method and apparatus for optical surface cleaning by liquid cleaner as foam

(75) Inventor: Brij Pal Singh, North Royalton, OH (US)

Correspondence Address: FAY SHARPE LLP, 1100 SUPERIOR AVENUE, SEVENTH FLOOR, CLEVELAND, OH, 44114, US

(73) Assignee: VisiChem Technology, LTD

(21) Appl. No.: 11/961,784

(22) Filed: Dec. 20, 2007

Related U.S. Application Data
(60) Provisional application No. 60/876,915, filed on Dec. 22, 2006.

(51) Int. Cl. B08B 3/04; B05B 9/04

(52) U.S. Cl. 134/40; 239/337; 222/251; 222/190

(57) ABSTRACT

A method for cleaning an associated optical surface using an optical surface liquid cleaner is provided. The method comprises providing the optical surface liquid cleaner. The liquid cleaner including one or more foam producing and surface cleaning agents. A foam dispenser is provided, the dispenser including a reservoir and a dispensing head in fluid communication with the reservoir. The reservoir of the dispenser is filled with the liquid cleaner. The dispensing head of the foam dispenser is actuated to produce a foam from the liquid cleaner. The foam is applied to the associated optical surface. The associated optical surface is rubbed with a pliable non-scratch material. An associated contaminant is emulsified on the surface of the associated optical surface. The surface of the associated optical surface is dried.

A claim for domestic priority is made herein under 35 U.S.C. §119(e) to U.S. Provisional App. Ser. No. 60/876,915 filed on Dec. 22, 2006, the entire disclosure of which is incorporated herein by reference.

### BACKGROUND

The present invention generally relates to a method and apparatus for cleaning an optical surface, such as a lens, using a liquid cleaner and dispensing the liquid cleaner as a foam.

Optical surfaces (e.g., eyeglass lenses) have been cleaned for long time using different products. Such cleaning products can include solvent based cleaners, ammonia based aqueous cleaners, water based liquid cleaners and pre-moistened lens cloth called “Wet-Wipes.” However, several disadvantages exist with the prior art cleaners. For one, the solvent-based cleaners as well as the ammonia based cleaners are not well accepted in the optical industry due to damage to the article surface as well as health and environmental issues. Water based liquid lens cleaners have been dispensed in small quantities using plastic drip cap bottles but more commonly are dispensed using pressure actuated spray bottle dispensers. In the case of the liquid spray method, the article to be cleaned is held in front of the spray bottle head and the spray head or pump head is quickly depressed or actuated to deliver the liquid cleaner on the surface.

Another disadvantage is that a full stroke of a dispenser mechanism (e.g., a pump head) of the prior art spray bottle dispenser is needed to deliver the liquid on the surface. The surface having the liquid cleaner is then wiped with a soft tissue or micro-fiber cloth to emulsify and remove the contaminants and excess liquid from the surface. In the case of the “Wet-Wipes”, the moist cloth is taken out from the sealed pouch and used to wipe clean the optical surface. Although these methods may work fine to clean the optical surfaces, they both have some inherent disadvantages. For example and with reference to FIG. 3, in the case of a prior art liquid spray bottle dispenser A, one does not have control of the amount of liquid B delivered, since it needs a full stroke of the spray head C. The liquid cleaner B delivered by the spray bottle dispenser A impacts the optical surface, such as an eyeglass lens D, at a relatively high velocity causing part of it to bounce off the surface. In addition, because the cleaner is delivered on the surface as a liquid, the liquid runs down the optical surface flowing into other fixtures of the article (e.g. an eyeglass frame E, a camera lens housing, a computer screen frame, etc.). The sprayed liquid may also collect to form a pool F on the optical surface and drips G or spills onto the user's person, and/or nearby objects H (e.g., a book, table, desk, floor, etc). Such excess or uncontrolled spray can cause blemishing I or other damage to occur to the nearby objects H as well as skin and/or respiratory irritation to the user. In addition, liquid cleaner can collect and dribble from an orifice/nozzle of the prior art spray bottle during its use causing liquid to flow down the bottle and further compounding the aforementioned problems.

Furthermore, during the prior art spray process, part of the product is sprayed in the air as an aerosol, which can raise health and environmental issues. In the case of the prior art “Wet-Wipes”, there is a high concentration of isopropyl alcohol (IPA) solvent in the formulation. A person using the “Wet-Wipes” will get their hands or skin exposed to the high concentration of alcohol as well as to certain other chemicals that may have an irritating effect on the sensitive skin.

Aerosol based liquid cleaners are also available to clean optical surfaces but include similar disadvantages as described previously. First, controlling the liquid to be delivered from a pressurized bottle can be difficult. Second, the liquid also sprays in the air. As such, health and environmental issues are a concern with this method of delivery.

Foam formulations have been used in a variety of consumer liquid products that include cleaning of hard surfaces in households, treating human skin and hair such as with shampoo, hair mousse, shaving creams and hand cleaners. However, none of these products use a liquid formulation designed for optical lenses or surfaces. Furthermore, most of these products are packed in an aerosol container or the container is pressurized with external air or propellant during use, as described in U.S. Pat. Nos. 3,974,965 and 4,646,973. Here again, controlling the amount of foam delivery on a small article is difficult with aerosol pumps.

Also, non-aerosol foam dispensing devices referred to as “Foam Pumps” or “Foam Spray Pumps” have been used to generate foam from liquid product using a liquid-air turbulent mixing system. In addition, squeezable flexible foam bottles, and their configurations have been described in U.S. Pat. Nos. 3,709,437; 3,937,364; 4,002,351 and 4,184,615 and have been used for producing foam from liquid products. However, these “foam pumps” have not been used in conjunction with optical surface cleaning.

Another category of foam pumps have also been used to dispense liquid products as foam and are mentioned in U.S. Pat. Nos. 5,220,483; 5,337,929; and WO 1997/013585 that are made of PE, HDPE and PET, manufactured and supplied by AirSpray International B.V. These foam pumps have been used to deliver commercial products such as skin and hair treatment and the same is disclosed in U.S. Pat. Nos. 5,364,031; 6,030,931; 6,264,964 and 6,497,866.

It is therefore an objective of the present invention to provide an improved method and apparatus for applying the liquid lens cleaner onto a lens or other optical surface, for controlling the amount of cleaner applied, and for cleaning of the optical surface.

### SUMMARY

According to one aspect, a method for cleaning an associated optical surface using an optical surface liquid cleaner is provided. The method includes providing the optical surface liquid cleaner. The liquid cleaner includes one or more foam producing and surface cleaning agents. A foam dispenser is provided, the dispenser including a reservoir and a dispensing head in fluid communication with the reservoir. The reservoir of the dispenser is filled with the liquid cleaner. The dispensing head of the foam dispenser is actuated to produce a foam from the liquid cleaner. The foam is applied to the associated optical surface. The associated optical surface is rubbed with a pliable non-scratch material. An associated contaminant is emulsified on the surface of the associated optical surface. The surface of the associated optical surface is dried.

According to another aspect, a method for cleaning an associated optical surface using a drip-resistant foamable liquid cleaner is provided. The method includes providing the foamable liquid cleaner, the cleaner including one or more foam producing and surface cleaning agents. A foam pump dispenser is provided, the dispenser includes a reservoir for receiving the liquid cleaner and a pump head in fluid communication with the reservoir. The reservoir of the foam pump dispenser is filled with the liquid cleaner. The foam pump dispenser is actuated to produce a foam from the liquid lens cleaner. The foam is applied to a pliable non-scratch material. The associated optical surface is rubbed with the foam laden pliable non-scratch material. An associated contaminant is emulsified on the associated optical surface. The surface of the associated optical surface is dried.

According to yet another aspect, an apparatus for producing a stable foam for cleaning an associated optical surface is provided. The apparatus includes a foam dispenser. The dispenser includes a reservoir and an aerating dispensing head in fluid communication with the reservoir for producing the stable foam. The dispensing head includes a nozzle for depositing the stable foam onto the associated optical surface. An optical surface liquid cleaner including one or more foam producing and surface cleaning agents. The liquid cleaner being disposed internally to the reservoir of the foam dispenser.

### BRIEF DESCRIPTION OF THE DRAWINGS

FIG. 1 is a perspective view of a first embodiment of a foam pump dispenser filled with a foaming liquid lens cleaner and a pair of eyeglass lenses.

FIG. 2 is a perspective view of the foam pump dispenser dispensing the liquid lens cleaner as a foam on a lens surface of the eyeglasses of FIG. 1.

FIG. 3 is a perspective view of a prior art spray bottle dispenser dispensing a liquid cleaner as a spray on a pair of eyeglass lenses.

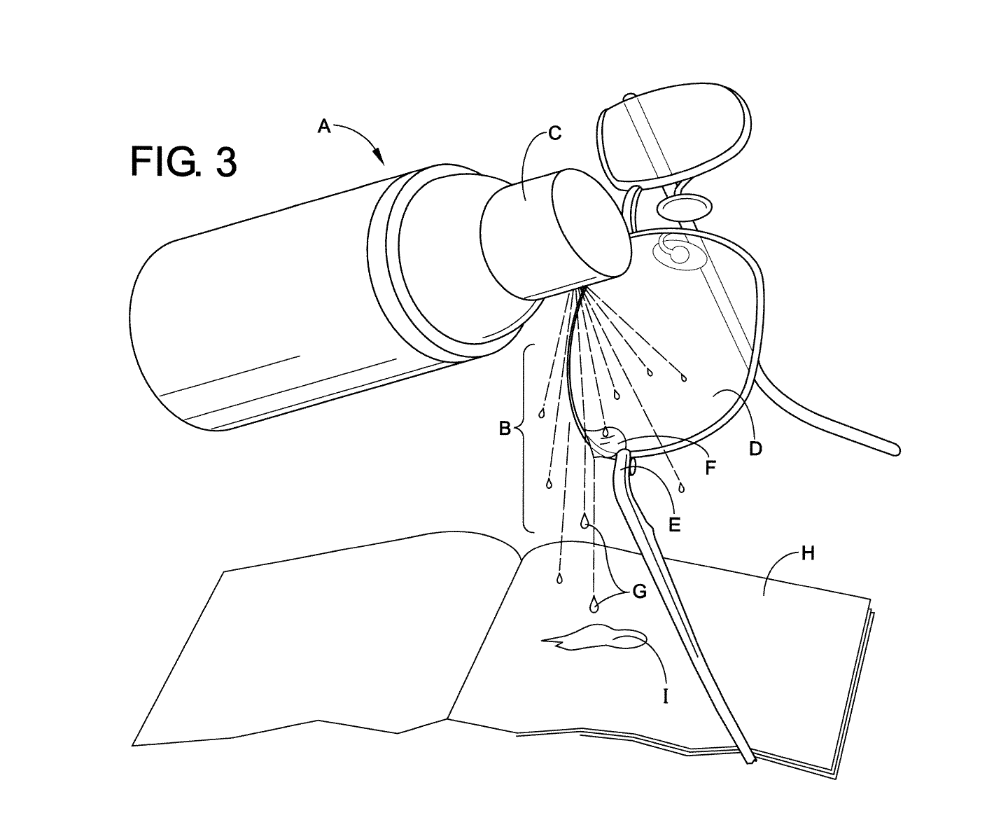

### DETAILED DESCRIPTION

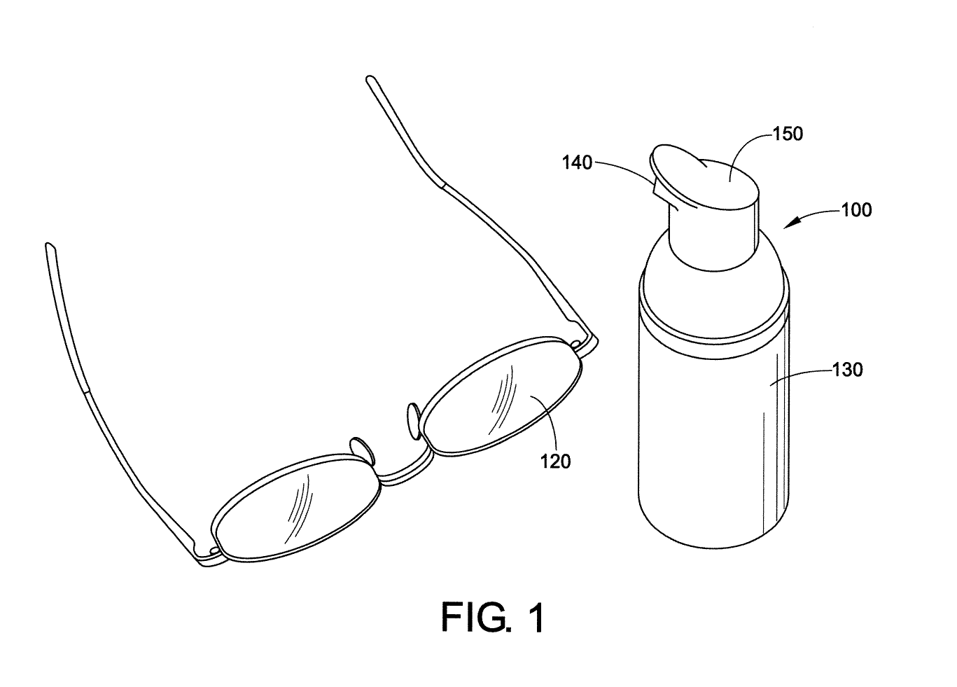

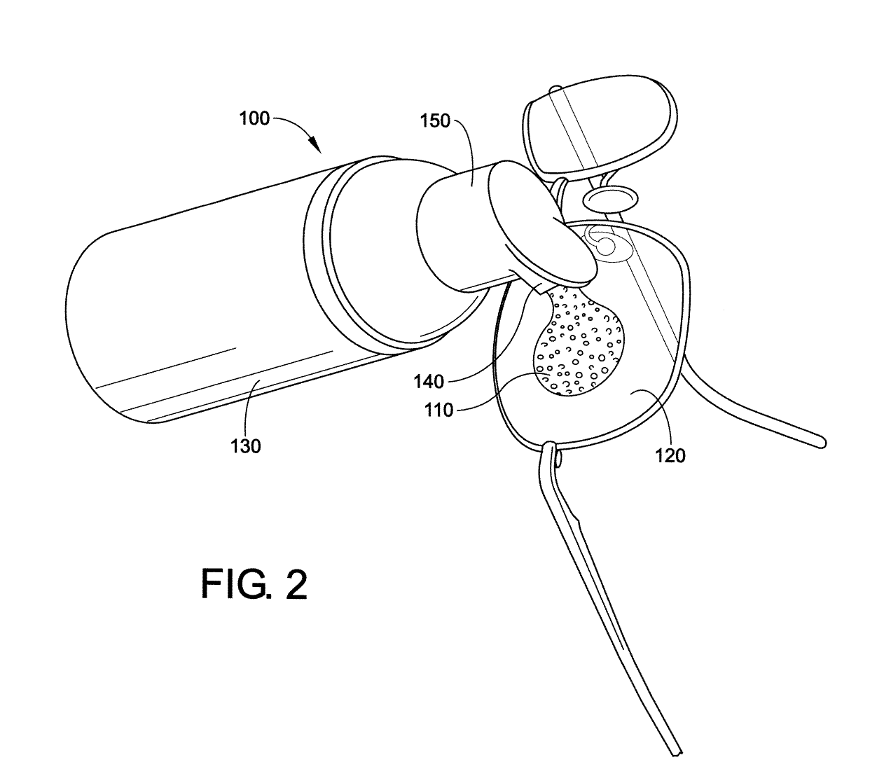

With reference to FIGS. 1-2, a first embodiment of the present invention involves a method and apparatus for cleaning and the delivery of a non-ammonia water based foamable liquid lens cleaner by using a foam pump dispenser 100 to deliver a controlled amount of the liquid cleaner in the form of a stable-foam 110 to an optical surface, such as an eyeglass lens 120. The liquid cleaner is supplied to a reservoir 130 of the foam dispenser 100 which is in fluid communication with a dispensing head or pump head assembly 150. The size of the foam pump reservoir could be 50-250 ml in volume. The foam is delivered to an optical surface by directing a nozzle 140 of the dispensing head or a pump head assembly 150 of the foam pump dispenser 100 near the optical surface and pressing downwards or otherwise actuating the pump head assembly 150. As the pump head 150 is pressed down, the air in the pump head assembly 150 aerates or mixes with the liquid cleaner and the liquid cleaner is expelled as stable-foam 110, without spilling or dripping any liquid from the nozzle 140. The amount of foam 110 delivered on to a surface to be cleaned is generally dependent on the stroke length (i.e., how far the spray head is pressed down). Next, a pliable non-scratch material such as a soft tissue paper or micro-fiber cloth can be used to gently spread the foam on the surface using, for example, a circular motion to emulsify the oil, grease and other contaminants on the surface. At this point, the contaminants are held within the foam composition. Lastly, a dry part of the tissue or the micro-fiber cloth can be used to dry the surface, leaving it completely clean. An alternate embodiment of the foam dispenser may include a flexible squeeze type reservoir such that the dispensing head of the dispenser need not require a separating pumping mechanism. In such case, the user delivers the liquid cleaner to the dispensing head by squeezing, for example, the sides of the reservoir thus causing the dispensing head to aerate the liquid cleaner and to produce the stable foam. As described previously, however, better results may be obtained by using the foam pumps from Airspray International B.V., Daiwa F2 foam pump from Yoshino Kogyosho Co., Ltd., Japan or the like as mentioned in U.S. Pat. No. 7,048,153.

One method of use according to the present invention generally includes filling the water-based foamable liquid lens cleaner in the manually-actuated non-aerosol foam dispenser and delivering it on the optical surface as approximately 95% as foam, instead of a pure liquid. As described here, the terms “Foamable Liquid Lens Cleaner”, mean a water-based liquid cleaner product that produces or dispenses foam when mixed with air, i.e. an aerated mixture of a liquid and air having density less than the non-aerated liquid. The foam produced from the liquid cleaner includes a plurality of air bubbles. The bubble size in the foam ranges from 0.1-2.0 mm diameter, depending upon the cleaner formulation, but preferably in the range of 0.2-1.0 mm diameter. This foam has a very slow flow rate on the optical surface as compared to liquid that is delivered as a liquid spray. According to the present method, a water based liquid lens cleaner that produces foam on mixing with air could be used within the foam pump and delivered as stable-foam on the optical surface to be cleaned.

Another method of applying the foam on the lens surface could involve applying a desired amount of liquid foam from the foam pump on to a small portion of the soft tissue paper or the micro-fiber cloth. Then, the foam from the paper or cloth can be applied to the optical surface and spread to emulsify the contaminants on the surface to be cleaned.

The present invention could also comprise a kit that contains the liquid cleaner in a separate bottle or reservoir together with an empty foam pump dispenser and pump head assembly, micro-fiber cloth and other accessories. The cleaner for the reservoir could be filled by the user or customer at the time of use and then foam can be generated to clean the optical surface. The liquid cleaner could also be pre-filled in a capped or sealed reservoir of the foam pump and packaged together with the foam pump head assembly. The customer can then later attach the pump head to the liquid reservoir and use it to generate foam from the liquid cleaner and clean a variety of optical or other lens type surfaces such as eyeglasses, sunglasses, safety glasses and goggles, computer screens, cell phone displays or windows, camera lenses, binacular lenses, telescope lenses, display screens, CDs, DVDs, etc.

The present invention involves the foam cleaning of the surface instead of liquid. In general, to clean a surface, the contaminants are emulsified on the surface into the liquid cleaner and lifted off by tissue paper or cloth. In the case of the foam cleaning, oil and other contaminants on the surface emulsify very effectively into the pre-generated foam and are lifted off by cloth completely. Thus, efficient cleaning of the surface compared to the prior art liquid spray cleaning method is achieved.

As an example, a liquid lens cleaner was formulated using 0.1-10% by weight of a mixture of anionic, cationic, non-ionic, amphoteric and polymeric surfactants together with water, IPA and other additives. This formulation was then used in accordance with the foam pump method described above to apply the liquid as foam on a dirty optical surface, such as a plastic lens surface. The foam was then rubbed on the surface with the help of a soft tissue paper and dried. Remarkably, the lens surface cleaned completely without any visible residue or haze on the lens.

In a second example, a liquid cleaner formulation was created using 1-10% by weight magnesium lauryl sulfate, 1-20% lauramide DEA, 1-5% sodium xylene sulfonate, 2-25% IPA, 60-90% water and other minor additives. The foam pump dispenser was then filled with the liquid formulation. By depressing the pump head assembly, a stable-foam was applied on the oily and finger print laden cell phone window or screen surface and successfully used to clean them without the cleaner leaking into the cell phone window housing or the display screen.

In a third example, a liquid lens cleaner formulation was produced using by weight 0.1-20% sodium lauryl sulfate, 2-15% IPA and 70-90% water together with minor additives. The foam pump was then filled with the liquid cleaner and was delivered as stable-foam onto a vertical display screen of a laptop computer. The cleaner as a stable foam adhered to the surface of the computer screen and moved downward very slowly. Thus proving that the cleaner does not leak into the computer screen frame or associated structures, immediately as it is applied. The computer screen surface was then rubbed clean with a micro-fiber cloth. Once again, the liquid cleaner as foam performed very well in cleaning the sensitive surface without causing any damage.

In a fourth example, other water based liquid products were formulated such as liquid anti-fog solution, liquid lens cleaner/anti-fog, anti-static solution, liquid cleaner/anti-static and liquid cleaner/hydrophobic solution, using different anionic, cationic, amphoteric and polymeric surfactants, water, IPA, and other additives. These formulations were then used in the foam pump dispenser described previously. All the products formed good stable-foam from the liquid formulations, cleaned the various optical surfaces as described previously while leaving behind an invisible additive film on the surface having a beneficial property such as, an anti-fog, anti-static or hydrophobic property.

In a fifth example, an in-house proprietary liquid lens cleaner formulation was tested for lens cleaning performance, using both the spray bottle method as well as the present foam pump dispenser method. In both cases, the in-house lens cleaner performed very well without leaving any visible residue or haze on the lens surface.

To compare the cleaning performance difference between the liquid spray method and the foam pump dispenser method as stable-foam, the in-house proprietary lens cleaner was tested at Colt Laboratories, Florida, USA, using their standardized and certified surface cleaning test method called “Oily Cleaning”, Test Method No. SOP # 23-10-03. The test procedure and data measuring is well explained in the test method and, as such, only general information pertaining thereto will be discussed herein. The performance of the lens cleaner is measured by putting a known amount of WD-40 oil on the surface of the lens and smearing it on the lens surface to make the surface dirty. The lens is held horizontally on a pivot arm of a BYK Gardner Haze-gard Plus instrument, keeping the convex side of the lens up. A known amount of lens cleaner is then applied on the dirty lens surface via a spray bottle (one full spray stroke). The lens surface is then rubbed with a known soft cloth attached to a moving vertical arm of the instrument. The moving arm is loaded with a known weight so as to apply a known or constant rubbing pressure on the lens surface. The haze present on the test lens is measured by a haze measuring instrument “Haze Meter” before starting the experiment and is used as a reference. Haze readings are then taken after 20, 40 and 60 rubs of the cloth and an average delta haze number for the spray bottle method was determined. The above experiment was then repeated, as above, with a new lens using the same lens cleaner but applied as a stable-foam according to the present invention using the foam pump dispenser. Again, using a known fresh soft cloth as above, an average delta haze number for the stable foam dispenser method was determined. The two delta haze numbers were then compared. The overall lens cleaner cleaning efficiency was determined according to the delta haze number. Generally, the lower the delta haze number the better the cleaning efficiency of the cleaning method.

Accordingly, the test data for the spray bottle and the foam pump dispenser methods were compared. In the case of the spray bottle, the delta haze number was found to be 0.53. By comparison, the same cleaner gave a delta haze number of 0.00 using the foam pump dispenser method. By this experiment, it is very clear that using the same lens cleaner but dispensing it as a stable foam via the foam pump method produces surprisingly better results and can be a very efficient method to clean any number of optical surfaces.

To further test the validity of the foam pump method, we formulated a number of liquid lens cleaners in-house and tested them using the spray bottle and foam pump cleaning methods. All lens cleaner formulations were tested using the above surface cleaning test method, SOP # 23-10-03 at Colts Laboratory, Florida. The test results, i.e. the delta haze numbers, of the different lens cleaner formulations using the spray bottle and foam pump methods are listed in Table-1 below.

TABLE 1
Delta haze numbers for “Oily Cleaning” for different liquid lens
cleaner formulations.

| | Delta Haze, | Delta Haze, |
|---|---|---|
| Liquid Lens Cleaner | Spray Method | Foam Pump Method |
| Formulation 1 | 0.73 | 0.11 |
| Formulation 2 | 0.75 | 0.15 |
| Formulation 3 | 0.79 | 0.16 |
| Formulation 4 | 0.53 | 0.00 |
| Formulation 5 | 0.54 | 0.00 |
| Formulation 6 | 0.53 | 0.00 |

It should be noted that Formulations 1-6 are a series of proprietary cleaner solutions which are referenced in the table above solely for the purpose of illustrating the advantages of the present invention. These formulations are not otherwise relevant to the instant disclosure.

Again, it is very clear from the delta haze numbers in Table-1 above, that lower delta haze numbers were produced in all of the foam pump method trials as compared to the spray bottle method trials, regardless which lens cleaner formulation was used. This clearly proves that the lens cleaner used according to the foam pump method of the present invention is a novel and superior lens cleaning method. In addition, the method is ideal for cleaning optical surfaces safely and harmlessly while reducing health and environmental issues. By contrast, the spray bottle method can damage optical equipment while dispersing the liquid lens cleaner in an unsafe, unhealthy and environmentally hazardous manner.

According to the method of the present invention, most of the liquid lens cleaners in the market could be used as foam to clean the lenses and other optical surfaces. In one example, and in accordance with the method of the present invention, a commercially available liquid lens cleaner, sold by Luxotica Optical in U.S.A., in spray bottles was filled in a 50 ml capacity foam pump dispenser, available from Airspray International B.V. To check the performance, the nozzle of the pump was directed onto a plastic lens surface and by depressing the pump head, the liquid was delivered as a stable-foam on the lens surface. In a controlled experiment, one plastic optical lens was contaminated using a small amount of WD-40 oil (50 micro liters) on the lens surface. The oil was smeared on the surface with a tissue paper just enough to make the lens surface dirty and greasy. Then, the above liquid lens cleaner was dispensed onto the lens surface as foam using the foam pump method according to the present invention. The lens surface was then wiped cleaned with a micro-fiber cloth. The results showed excellent cleaning of the lens surface without any drip of solution (i.e. run off from lens surface) and was not atomized in the air, as in the prior art spray bottle method.

In yet another example, another liquid lens cleaner in spray bottles sold by Wal-Mart Stores, Inc., U.S.A., was filled in a 50 ml capacity foam pump dispenser, as above, and tested for the cleaner performance using one plastic lens and WD-40 oil. Again, the cleaning performance of the dispensed stable-foam was observed to be excellent without any apparent residue, haze, dripping, or run off of the cleaner from the lens surface. Therefore, the liquid cleaner by foam pump method cleans the optical lens surface well while providing the benefits and advantages associated with the foam pump method discussed previously.

Thus, as is evident from the above descriptions, the present invention confirms many benefits while accomplishing numerous objectives. For example, it would be an objective of the invention to have liquid cleaner applied in a safer way without spilling it on the clothes or floor. It would be another objective of the invention to apply the liquid cleaner on an optical surface without spraying it in the air. It would be still another objective of the invention to apply the liquid cleaner in a controlled way so that it does not get into eyeglass frames and other fixtures of the optical articles. It would be yet another objective of the present invention to apply the liquid cleaner in a safer and in a controlled manner, such as by using foam, thus minimizing the negative health and environmental issues associated with the prior art spray method. It would be still yet another main objective of the present invention to apply the liquid cleaner as foam using a non-aerosol device.

It will be appreciated that the above-disclosed exemplary embodiments and other features and functions, or alternatives thereof, may be desirably combined into a variety of different systems or applications. Also, presently unforeseen or unanticipated alternatives, modifications, variations or improvements therein may be subsequently made by those skilled in the art which are also intended to be encompassed by the following claims. It is thus intended that the exemplary embodiments be construed as including all such modifications and alterations insofar as they come within the scope of the appended claims or the equivalents thereof.

1. A method for cleaning an associated optical surface using an optical surface liquid cleaner, the method comprising:
providing the optical surface liquid cleaner, the liquid cleaner including one or more foam producing and surface cleaning agents;
providing a foam dispenser, the dispenser including a reservoir and a dispensing head in fluid communication with the reservoir;
filling the reservoir of the dispenser with the liquid cleaner;
actuating the dispensing head of the foam dispenser to produce a foam from the liquid cleaner;
applying the foam to the associated optical surface;
rubbing the associated optical surface with a pliable non-scratch material;
emulsifying an associated contaminant on the surface of the associated optical surface; and
drying the surface of the associated optical surface.

2. The method of claim 1, wherein the dispenser head includes a manually actuated pump for aerating the liquid cleaner as it is being dispensed.

3. The method of claim 1, wherein the reservoir of the foam dispenser includes a flexible squeeze reservoir for aerating the liquid cleaner as the reservoir is squeezed and dispensed from the dispensing head.

4. The method of claim 1, further including the step of directing a nozzle of the pump assembly proximal to the associated optical surface prior to actuating the pump assembly.

5. The method of claim 1, wherein the liquid cleaner is a water-based solution.

6. The method of claim 1, where the liquid cleaner is at least one of an eyeglass lens cleaner, an anti-fog solution, an anti-static solution, or a hydrophobic solution.

7. The method of claim 1, wherein the associated optical surface is a lens made from one of a CR-39^{R}, polycarbonate, acrylic or high-index plastic.

8. The method of claim 7, wherein the lens is a glass lens or a plastic anti-reflective lens.

9. The method of claim 1, wherein the associated optical surface is an eyeglass lens, a sunglass lens, a safety glass lens, a sport goggles lens, a plastic photochromic lens, a glass photochromic lens, a binocular lens, a telescope lens, an optical instrument lens, a microscope lens, or a camera lens, a face safety shield, a display screen, a computer screen, a television screen, a touch panel screen, a reflective mirror, a light filter, a cell phone window, a CD, or a DVD.

10. A method for cleaning an associated optical surface using a drip-resistant foamable liquid cleaner, the method comprising:
providing the foamable liquid cleaner, the cleaner including one or more foam producing and surface cleaning agents;
providing a foam pump dispenser, the dispenser including a reservoir for receiving the liquid cleaner and a pump head in fluid communication with the reservoir;
filling the reservoir of the foam pump dispenser with the liquid cleaner;
actuating the foam pump dispenser to produce a foam from the liquid lens cleaner;
applying the foam to a pliable non-scratch material;
rubbing the associated optical surface with the foam laden pliable non-scratch material;
emulsifying an associated contaminant on the associated optical surface; and
drying the surface of the associated optical surface.

11. The method of claim 10, wherein the pliable non-scratch material is one of a soft tissue, soft cotton cloth or micro-fiber cloth.

12. The method of claim 10, wherein the step of applying foam further includes controlling the amount of foam produced and applied to the associated optical surface.

13. The method of claim 10, further including the step of spreading the foam on the associated optical surface using the pliable non-scratch material and then wiping the excess foam using a dry portion of the pliable non-scratch material.

14. An apparatus for producing a stable foam for cleaning an associated optical surface, the apparatus comprising:
a foam dispenser, the dispenser including a reservoir and an aerating dispensing head in fluid communication with the reservoir for producing the stable foam, the dispensing head including a nozzle for depositing the stable foam onto the associated optical surface; and
an optical surface liquid cleaner, the liquid cleaner including one or more foam producing and surface cleaning agents, the liquid cleaner being disposed internally to the reservoir of the foam dispenser.

15. The apparatus of claim 14, where the liquid cleaner is at least one of an eyeglass lens cleaner, an anti-fog solution, an anti-static solution, or a hydrophobic solution.

16. The apparatus of claim 14, wherein the associated optical surface is a lens made from one of a CR-39^{R}, polycarbonate, acrylic, high-index plastic, anti-reflective plastic, or glass.

17. The apparatus of claim 14, wherein the liquid cleaner is formulated using 0.1-10% by weight a mixture of anionic, cationic, non-ionic, amphoteric and polymeric surfactants together with water, IPA, or a mixture thereof.

18. The apparatus of claim 14, wherein the dispensing head includes a manually actuated pump for aerating the liquid cleaner as it is being dispensed.

19. The apparatus of claim 14 wherein the reservoir of the foam dispenser includes a flexible squeeze reservoir for aerating the liquid cleaner as the reservoir is squeezed and dispensed from the dispensing head.

20. The apparatus of claim 14, wherein the dispensing head dispenses the liquid cleaner as approximately 95% as stable foam.
